(19) United States
(12) Patent Application Publication
(10) Pub. No.: US 2024/0421352 A1
(43) Pub. Date: Dec. 19, 2024

(54) SOLID-STATE ELECTROLYTE FOR SOLID-STATE BATTERY, SOLID-STATE BATTERY, AND BATTERY PACKAGE

(71) Applicant: Murata Manufacturing Co., Ltd., Nagaokakyo-shi (JP)

(72) Inventor: Daisuke ITO, Nagaokakyo-shi (JP)

(21) Appl. No.: 18/821,239

(22) Filed: Aug. 30, 2024

Related U.S. Application Data
(63) Continuation of application No. PCT/JP2023/012747, filed on Mar. 29, 2023.

(30) Foreign Application Priority Data
Mar. 31, 2022 (JP) 2022-057998

(51) Int. Cl. H01M 10/0562

(52) U.S. Cl. CPC H01M 10/0562; H01M 2300/008

(57) ABSTRACT

A solid-state electrolyte for a solid-state battery, the solid-state electrolyte including: a lithium salt solid-state electrolyte part; and a non-lithium compound part embedded in the lithium salt solid-state electrolyte part. Preferably, the lithium salt solid-state electrolyte part has an antiperovskite structure, and the non-lithium compound part includes an inorganic insulating material.

### CROSS REFERENCE TO RELATED APPLICATIONS

The present application is a continuation of International application No. PCT/JP2023/012747, filed Mar. 29, 2023, which claims priority to Japanese Patent Application No. 2022-057998, filed Mar. 31, 2022, the entire contents of each of which are incorporated herein by reference.

### TECHNICAL FIELD

The disclosure relates to: a solid-state electrolyte for a solid-state battery; a solid-state battery including the solid-state electrolyte for a solid-state battery; and a battery package including the solid-state electrolyte for a solid-state battery.

### BACKGROUND ART

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. Recently, a solid-state battery has been developed that is a secondary battery including a solid-state electrolyte instead of a liquid or gel electrolyte that includes a material such as an organic solvent (for example, see PTLs 1 and 2 and NPTL 1).
PTL 1: International Publication No. WO 2019/221042
PTL 2: International Publication No. WO 2018/131181
NPTL 1: “Garnet-Based All-Ceramic Lithium Battery Enabled by Li_{2.985}B_{0.005}OCl Solder”, Wuliang Feng et al., iScience, 23, 101071 (2020)

### SUMMARY OF THE DISCLOSURE

Consideration has been given in various ways to improve performance of a solid-state battery, as described in the literatures in the above citation list. There is, however, room for improvement in terms of the performance of the solid-state battery.

It is therefore desirable to provide a solid-state electrolyte for a solid-state battery having superior performance.

A solid-state electrolyte for a solid-state battery of an embodiment of the disclosure includes a lithium salt solid-state electrolyte part, and a non-lithium compound part embedded in the lithium salt solid-state electrolyte part.

According to the solid-state electrolyte for a solid-state battery of the embodiment of the disclosure, the lithium salt solid-state electrolyte part and the non-lithium compound part including no lithium are combined. This allows the solid-state electrolyte for a solid-state battery of the embodiment of the disclosure to achieve superior performance. For example, it is possible for the solid-state electrolyte for a solid-state battery of the embodiment of the disclosure to have a favorable ion conductive property and chemical stability.

Note that effects of the disclosure are not necessarily limited to those described above and may include any of a series of effects described below in relation to the disclosure.

### BRIEF DESCRIPTION OF THE DRAWINGS

FIG. 1 is a schematic sectional diagram illustrating an example of a configuration of a solid-state electrolyte as a first embodiment of the disclosure.

FIG. 2 is a schematic sectional diagram illustrating a configuration of a battery package as a second embodiment of the disclosure.

FIG. 3 is a sectional diagram illustrating a configuration of a solid-state battery illustrated in FIG. 2.

### DESCRIPTION OF THE PREFERRED EMBODIMENTS

Some embodiments of the disclosure are described below in detail with reference to the drawings.

Note that a “solid-state battery” of the disclosure refers to a battery including a component that is in a solid state. For example, the “solid-state battery” of the disclosure is a stacked-type solid-state battery in which layers are stacked on each other. The layers each include, for example, a sintered body. The “solid-state battery” of the disclosure encompasses not only a secondary battery that is repeatedly chargeable and dischargeable but also a primary battery that is simply dischargeable.

### Outline of Disclosure

First, an outline of the disclosure is described.

Consideration has been given in various ways in relation to improvement in performance of a solid-state battery. The solid-state battery includes a solid-state electrolyte, and therefore typically has superior high-temperature resistance and high safety, as compared with a battery including a liquid electrolyte.

An inorganic solid-state electrolyte is typically in particle form, and lithium has to move across an interface between solid-state electrolyte particles. Even in a material having a high lithium ion conductivity (bulk conductivity) inside a particle, a lithium ion conductivity (a grain boundary conductivity) at the particle interface easily decreases.

In PTL 1 described above, a solid-liquid-state mixed electrolyte having a high lithium ion conductivity is configured by mixing particles of a Li oxide solid-state electrolyte (Li₇La₃Zr₂O₁₂) having a garnet structure and an ionic liquid with each other to form an interface between the particles of the solid-state electrolyte with the ionic liquid interposed therebetween. However, the solid-liquid-state mixed electrolyte described in PTL1 is a liquid-containing cell, which causes a concern about a possibility of leakage of the ionic liquid. Accordingly, sealing measures different from sealing measures for an all-solid-state battery are necessary.

In NPTL1 described above, particles of a solid-state electrolyte (Li₇La₃Zr₂O₁₂) having a garnet structure, which is a garnet-type solid-state electrolyte, and a solid-state electrolyte (Li₃OCl) having an antiperovskite structure with a low melting point, which is an antiperovskite-type solid-state electrolyte, are mixed with each other, and the antiperovskite-type solid-state electrolyte is melted to be brought into contact with the garnet-type solid-state electrolyte to form a mixed solid-state electrolyte layer having a small void. The solid-state electrolyte in NPTL 1 has an ion conductivity of 1×10⁴ S/cm. However, a Li oxide solid-state electrolyte having a garnet structure and a Li oxide solid-state electrolyte having a perovskite structure are expensive, and a Li state on a material surface of each of the Li oxide solid-state electrolytes easily changes in property. Specifically, the following changes easily occur in the Li state: change to a state where Li is excessive, change to a state where Li is deficient, and formation of a different phase such as Li₂O, Li₂CO₃, or LiOH. Such change in property of the Li state on the material surface involves significant change in interface resistance. Accordingly, even the solid-state electrolyte can fail to make use of a high lithium ion conductivity of the Li oxide solid-state electrolyte.

Further, PTL 2 described above discloses a mixed solid-state electrolyte layer including particles of a Li oxide solid-state electrolyte (Li₇La₃Zr₂O₁₂) having a garnet structure and a halogenated lithium hydrate (LiI·3H₂O). The mixed solid-state electrolyte layer has an ion conductivity of 6.2×10⁻³ S/cm. However, the Li oxide solid-state electrolyte has a property of easily causing a deterioration reaction due to moisture. The particles of the Li oxide solid-state electrolyte can deteriorate due to moisture derived from the hydrate that is LiI·3H₂O included in the mixed solid-state electrolyte layer. In this case, the ion conductivity decreases during long-term use. For example, a dehydration initiation temperature of LiCl·3H₂O is about 50° C., and a stable operation is difficult at a high temperature of 50° C. or higher. Further, LiCl·3H₂O is almost dehydrated at 100° C. Accordingly, various side reactions due to moisture generated at 100° C. result in deterioration in battery characteristic.

In view of the above-described circumstances, the Applicant proposes below a solid-state electrolyte, for a solid-state battery, having superior performance such as being resistant to a deterioration reaction due to moisture and having a higher ion conductive property, and a solid-state battery including the same.

### 1. First Embodiment

### <1.1 Configuration of Solid-State Electrolyte for Solid-State Battery>

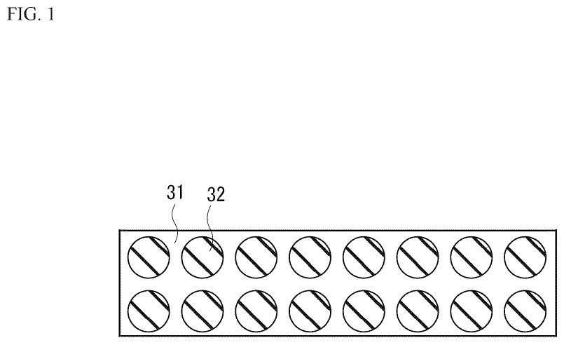

Referring to FIG. 1, a description is given of a solid-state electrolyte for a solid-state battery as a first embodiment of the disclosure. FIG. 1 is a schematic sectional diagram schematically illustrating an example of a configuration of the solid-state electrolyte for a solid-state battery. The solid-state electrolyte for a solid-state battery in FIG. 1 is a mixture including a first part 31 and a second part 32.

The first part 31 is a part including a lithium salt solid-state electrolyte. The first part 31 has an antiperovskite structure. The first part 31 preferably has a melting point of 400° C. or lower. Specifically, the first part 31 preferably includes at least one of Li₃OCl, Li₂(OH)Cl, or Li₂(OH)Cl_{0.9}F_{0.1}. Li₃OCl, Li₂(OH)Cl, Li₂(OH)Cl_{0.9}F_{0.1} each has a lattice constant of 3.91 Å. Further, the first part 31 may include at least one of Li₃OCl in which Cl is completely or partially substituted with fluorine (F), bromine (Br), or iodine (I), or Li₂(OH)Cl in which Cl is completely or partially substituted with fluorine (F), bromine (Br), or iodine (I).

The second part 32 is embedded in the first part 31. The second part 32 is a part including a non-lithium compound. The non-lithium compound may not be an electrolyte. The part including a non-lithium compound includes an inorganic insulating material. Examples of the inorganic insulating material include a metal oxide and a metal nitride. Specifically, used as the inorganic insulating material may be at least one of Al₂O₃, ZrO₂, or TiO₂. Further, Nb₂O₅ or BaTiO₃ may be used for the inorganic insulating material as the non-lithium compound part. Note that the insulating material used in the disclosure refers to, for example, a material having a band gap of 3.5 eV or greater.

Multiple second parts 32 are dispersedly provided in the first part 31. The first part 31 is so provided as to fill a gap between the second parts 32. The second parts 32 each preferably have a median diameter D50 of greater than or equal to 5 nm and less than or equal to 5 μm. The first part 31 is a part resulting from causing a molten lithium salt to permeate the gap between the second parts 32 and thereafter crystallizing the molten lithium salt. The molten lithium salt is a salt resulting from melting the lithium salt solid-state electrolyte. The first part 31 is preferably meltable at a temperature lower than 400° C.

### <1.2 Method of Manufacturing Solid-State Electrolyte for Solid-State Battery>

A description is given next of an example of a method of manufacturing the solid-state electrolyte for a solid-state battery.

First, solid-state electrolyte powder as the first part 31, non-lithium compound powder as the second part 32, and an organic binder are kneaded with each other to fabricate a kneaded powder body. Thereafter, the kneaded powder body is compression-molded while being heated by, for example, a hot isostatic press (HIP) method to thereby fabricate a compression-molded body. At this time, the kneaded powder body is desirably compression-molded while being heated at a temperature high enough to melt the solid-state electrolyte powder (for example, a temperature of higher than or equal to 200° C. and lower than 400° C.). Such compression-molding with heating allows the kneaded powder body to be dehydrated, and allows the first part 31 and the second part 32 to be ionically bonded. In such a manner, the solid-state electrolyte for a solid-state battery of the embodiment is obtained.

### <1.3 Action and Effects of Solid-State Electrolyte for Solid-State Battery>

In the solid-state electrolyte for a solid-state battery, the second parts 32 each including the non-lithium compound are embedded in the first part 31 including the lithium salt solid-state electrolyte. Combining a lithium salt solid-state electrolyte part and a non-lithium compound part including no lithium in such a manner allows the solid-state electrolyte for a solid-state battery of the embodiment to achieve superior performance such as having a favorable ion conductive property. It is therefore possible for the solid-state electrolyte for a solid-state battery to have a high ion conductivity, and when a solid-state battery includes the solid-state electrolyte for a solid-state battery, it is possible for the solid-state battery to allow for fast charging and high output.

The solid-state electrolyte for a solid-state battery is allowed to include no Li oxide solid-state electrolyte. Accordingly, the solid-state electrolyte for a solid-state battery including no Li oxide solid-state electrolyte is superior in chemical stability to a solid-state electrolyte including the Li oxide solid-state electrolyte. The Li oxide solid-state electrolyte has a property of easily causing a reaction with water and easily changing in property, as described above. Accordingly, the Li oxide solid-state electrolyte is susceptible to change in humidity (a humidity environment) and is difficult to handle. In this regard, because the solid-state electrolyte for a solid-state battery of the embodiment is allowed to include no Li oxide solid-state electrolyte, it is possible for the solid-state electrolyte for a solid-state battery to have a high chemical stability.

### 2. Second Embodiment

### <2.1 Battery Package 100>

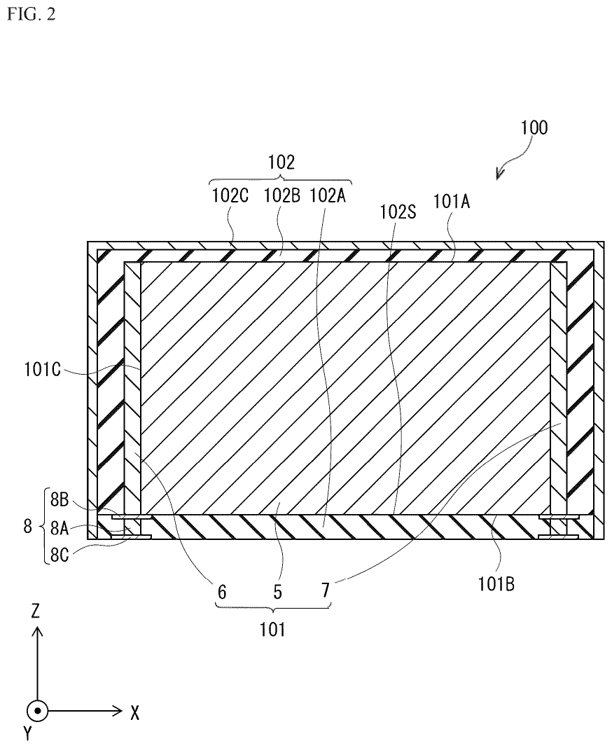

A description is given next of a battery package 100 of a second embodiment of the disclosure. FIG. 2 is a schematic sectional diagram schematically illustrating an overall configuration of the battery package 100. The battery package 100 includes a solid-state battery 101 and a covering part 102 that covers the solid-state battery 101. The solid-state battery 101 is protected from an external environment by the covering part 102. The covering part 102 helps to prevent entry of, for example, water vapor into the solid-state battery 101. In the following, a description is given of the solid-state battery 101, and thereafter of the covering part 102. As used herein, “water vapor” refers to moisture typified by water vapor in the atmosphere, and refers to moisture encompassing not only water vapor in a gas state but also water in a liquid state in some preferred embodiments. The solid-state battery 101 protected against permeation of such moisture is preferably packaged to be suitable for mounting on a substrate, in particular, for mounting on a surface.

### <2.2 Solid-State Battery 101>

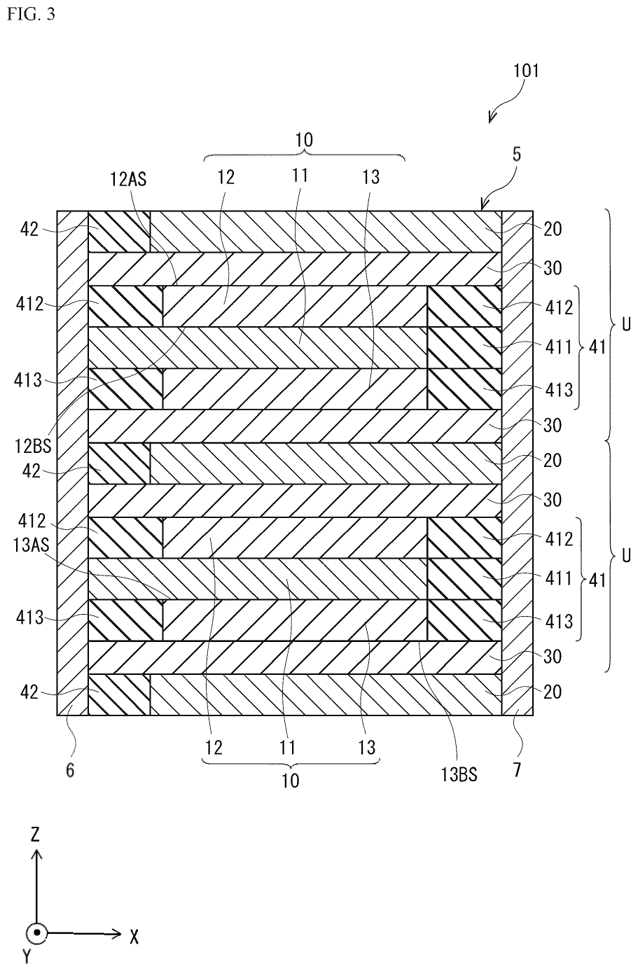

FIG. 3 is a schematic sectional diagram schematically illustrating a configuration of the solid-state battery 101. As illustrated in FIGS. 2 and 3, the solid-state battery 101 includes a stacked body 5, a positive electrode terminal 6, and a negative electrode terminal 7. The positive electrode terminal 6 and the negative electrode terminal 7 are opposed to each other with the stacked body 5 interposed therebetween. As illustrated in FIG. 3, the stacked body 5 includes a positive electrode layer 10, a negative electrode layer 20, and a solid-state electrolyte layer 30 that are stacked on each other in a Z-axis direction. The solid-state electrolyte layer 30 is interposed between the positive electrode layer 10 and the negative electrode layer 20 in the Z-axis direction that is a stacking direction. The solid-state battery 101 specifically has a structure in which multiple units U are stacked on each other in the Z-axis direction. The units U each serve as a single unit and each include the negative electrode layer 20, the solid-state electrolyte layer 30, the positive electrode layer 10, and the solid-state electrolyte layer 30 that are stacked on each other in order. Note that FIG. 3 illustrates the solid-state battery 101 including two units U; however, the solid-state battery 101 is not limited to this example, and may include three or more units U. The solid-state battery 101 may further include margin layers 41 and 42 that are each an electron insulating layer. The margin layer 41 is provided at the same layer level as a portion of the positive electrode layer 10. The margin layer 42 is provided at the same layer level as a portion of the negative electrode layer 20.

The positive electrode layer 10 and the negative electrode layer 20 may each include a conductive additive. The conductive additive that may be included in each of the positive electrode layer 10 and the negative electrode layer 20 may include, for example, at least one selected from the group consisting of, for example: a metal material such as silver, palladium, gold, platinum, copper, or nickel; and carbon. The conductive additive included in the positive electrode layer 10 and the conductive additive included in the negative electrode layer 20 may be of the same kind, or may be of respective kinds different from each other.

### (Positive Electrode Layer 10)

The positive electrode layer 10 is an electrode layer including at least a positive electrode active material. In the solid-state battery 101 illustrated in FIG. 3, the positive electrode layer 10 includes a stacked structure including a positive electrode current collector 11 and a pair of positive electrode active material layers 12 and 13.

The positive electrode current collector 11 is, for example, a metal foil such as an aluminum foil. Note that FIG. 3 illustrates, as an example, an embodiment where the positive electrode layer 10 includes the positive electrode current collector 11; however, the positive electrode current collector 11 is not an essential component. In some embodiments, the positive electrode layer 10 may include no positive electrode current collector 11 and may include either the positive electrode active material layer 12 or the positive electrode active material layer 13.

### (Positive Electrode Active Material Layers 12 and 13)

The positive electrode active material layers 12 and 13 each include the positive electrode active material as a major component. The positive electrode active material layer 12 is provided on an upper surface of the positive electrode current collector 11, and the positive electrode active material layer 13 is provided on a lower surface of the positive electrode current collector 11.

The positive electrode active material included in each of the positive electrode active material layers 12 and 13 contributes to insertion and extraction of an ion in the solid-state battery 101 and also contributes to supplying and receiving of an electron to and from an external circuit. The ion moves between the positive electrode layer 10 and the negative electrode layer 20 via the solid-state electrolyte. In other words, ion conduction occurs between the positive electrode layer 10 and the negative electrode layer 20 via the solid-state electrolyte.

The insertion and extraction of the ion into and from the positive electrode active material involve reduction and oxidation of the positive electrode active material. An electron and a hole for such reduction and oxidation reactions are respectively supplied from the external circuit to the positive electrode terminal 6 and the negative electrode terminal 7, and further respectively supplied to the positive electrode layer 10 and the negative electrode layer 20. This allows charging and discharging to proceed. The positive electrode active material layers 12 and 13 are each, for example, a layer which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. That is, the solid-state battery 101 is preferably an all-solid-state secondary battery that is to be charged and discharged by the above-described ion moving between the positive electrode layer 10 and the negative electrode layer 20 via the solid-state electrolyte.

### (Positive Electrode Active Material)

The positive electrode active material included in the positive electrode layer 10 includes, for example, at least one selected from the group consisting of, for example, a lithium-containing phosphoric acid compound having a NASICON structure, a lithium-containing phosphoric acid compound having an olivine structure, a lithium-containing layered oxide, and a lithium-containing oxide having a spinel structure. Examples of the lithium-containing phosphoric acid compound having the NASICON structure include Li₃V₂(PO₄)₃. Examples of the lithium-containing phosphoric acid compound having the olivine structure include Li₃Fe₂(PO₄)₃, LiFePO₄, LiMnPO₄, and LiFe_{0.6}Mn_{0.4}PO₄. Examples of the lithium-containing layered oxide include LiCoO₂, LiCo_{1/3}Ni_{1/3}Mn_{1/3}O₂, and LiCo_{0.8}Ni_{0.15}Al_{0.05}O₂. Examples of the lithium-containing oxide having the spinel structure include LiMn₂O₄ and LiNi_{0.5}Mn_{1.5}O₄.

The positive electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, a sodium-containing layered oxide, and a sodium-containing oxide having a spinel structure.

### (Negative Electrode Layer 20)

The negative electrode layer 20 is an electrode layer including at least a negative electrode active material. The negative electrode layer 20 may include a negative electrode current collector. The negative electrode current collector is, for example, a metal foil such as a copper foil.

### (Negative Electrode Active Material)

As with the positive electrode active material included in the positive electrode layer 10, the negative electrode active material included in the negative electrode layer 20 contributes to insertion and extraction of an ion in the solid-state battery 101 and also contributes to supplying and receiving of an electron to and from an external circuit. The ion moves between the positive electrode layer 10 and the negative electrode layer 20 via the solid-state electrolyte layer 30. In other words, ion conduction occurs between the positive electrode layer 10 and the negative electrode layer 20 via the solid-state electrolyte layer 30. The insertion and extraction of the ion into and from the negative electrode active material involve oxidation and reduction of the negative electrode active material. An electron and a hole for such oxidation and reduction reactions are respectively supplied from the external circuit to the positive electrode terminal 6 and the negative electrode terminal 7, and further respectively supplied to the positive electrode layer 10 and the negative electrode layer 20, which allows charging and discharging to proceed. The negative electrode active material is, for example, a material which a lithium ion, a sodium ion, a proton (H⁺), a potassium ion (K⁺), a magnesium ion (Mg²⁺), an aluminum ion (Al₃⁺), a silver ion (Ag⁺), a fluoride ion (F⁻), or a chloride ion (Cl⁻) is insertable into and extractable from. The negative electrode active material included in the negative electrode layer 20 includes, for example, at least one selected from the group consisting of, for example: an oxide including at least one element selected from the group consisting of Ti, Si, Sn, Cr, Fe, Nb, and Mo; a graphite-lithium compound; a lithium alloy; a lithium-containing phosphoric acid compound having a NASICON structure; a lithium-containing phosphoric acid compound having an olivine structure; and a lithium-containing oxide having a spinel structure. Examples of the lithium alloy include Li—Al. Examples of the lithium-containing phosphoric acid compound having the NASICON structure include Li₃V₂(PO₄)₃ and LiTi₂(PO₄)₃. Examples of the lithium-containing phosphoric acid compound having the olivine structure include Li₃Fe₂(PO₄)₃ and LiCuPO₄. Examples of the lithium-containing oxide having the spinel structure include Li₄Ti₅O₁₂.

The negative electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, and a sodium-containing oxide having a spinel structure.

### (Solid-State Electrolyte Layer 30)

The solid-state electrolyte layer 30 forms a layer conductive of, for example, a lithium ion between the positive electrode layer 10 and the negative electrode layer 20. The solid-state electrolyte for a solid-state battery described in the first embodiment above is adoptable for the solid-state electrolyte layer 30.

### (Positive Electrode Terminal 6 and Negative Electrode Terminal 7)

The positive electrode terminal 6 and the negative electrode terminal 7 are each an external coupling terminal adapted to couple the stacked body 5 and an external device to each other. The positive electrode terminal 6 and the negative electrode terminal 7 are each preferably provided as an end face electrode on a side surface of the stacked body 5. That is, the positive electrode terminal 6 and the negative electrode terminal 7 each extend along the Z-axis direction that is the stacking direction of the stacked body 5. In FIG. 3, the positive electrode terminal 6 and the negative electrode terminal 7 are opposed to each other in an X-axis direction. The positive electrode terminal 6 is electrically coupled to an end face of the positive electrode current collector 11 of the positive electrode layer 10, as illustrated in FIG. 3. The negative electrode terminal 7 is electrically coupled to an end face of the negative electrode layer 20. The positive electrode terminal 6 and the negative electrode terminal 7 each preferably include a material having a high electrical conductivity. The positive electrode terminal 6 and the negative electrode terminal 7 may each include, for example, at least one material selected from the group consisting of gold, silver, platinum, aluminum, tin, nickel, copper, manganese, cobalt, iron, titanium, and chromium. However, the material included in each of the positive electrode terminal 6 and the negative electrode terminal 7 is not limited to the above-described materials.

### (Margin Layers 41 and 42)

The margin layer 41 includes margin parts 411 to 413. The margin part 411 is provided at the same layer level as the positive electrode current collector 11, between the positive electrode current collector 11 and the negative electrode terminal 7. The margin part 412 is provided at the same layer level as the positive electrode active material layer 12, between the positive electrode active material layer 12 and each of the positive electrode terminal 6 and the negative electrode terminal 7. The margin part 413 is provided at the same layer level as the positive electrode active material layer 13, between the positive electrode active material layer 13 and each of the positive electrode terminal 6 and the negative electrode terminal 7. The margin layer 42 is provided at the same layer level as the negative electrode layer 20, between the negative electrode layer 20 and the positive electrode terminal 6.

The margin parts 411 to 413 of the margin layer 41 and the margin layer 42 each include, for example, a material having an electron insulating property. The material having the electron insulating property is hereinafter simply referred to as an “insulating material”.

Examples of the insulating material include a glass material and a ceramic material. The glass material may include, without limitation, at least one selected from the group consisting of soda-lime glass, potash glass, boric-acid-salt-based glass, borosilicic-acid-salt-based glass, barium-borosilicate-based glass, zinc-borate-based glass, barium-borate-based glass, bismuth-borosilicate-salt-based glass, bismuth-zinc-borate-based glass, bismuth-silicate-based glass, phosphoric-acid-salt-based glass, aluminophosphate-based glass, and zinc-phosphate-based glass, for example. The ceramic material may include, without limitation, at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃), for example.

The insulating material included in each of the margin layers 41 and 42 may include a solid-state electrolyte. In such a case, the solid-state electrolyte included in the insulating material is preferably the same material as the solid-state electrolyte included in the solid-state electrolyte layer 30. A reason for this is that such a configuration makes it possible to further improve a binding property between each of the margin layers 41 and 42 and the solid-state electrolyte layer 30.

### <2.3 Covering Part 102>

As illustrated in FIG. 2, the covering part 102 of the battery package 100 includes a support substrate 102A, an insulating covering film 102B, and an inorganic covering film 102C. In the battery package 100, the entire solid-state battery 101 is surrounded by the covering part 102. In other words, the covering part 102 is so provided as to prevent the solid-state battery 101 from being exposed to an outside.

### (Support Substrate 102A)

The support substrate 102A is a plate-shaped member that supports the solid-state battery 101. The support substrate 102A includes a surface 102S opposed to a bottom surface 101B that is a major surface of the solid-state battery 101. The support substrate 102A may be a resin substrate, or may be a ceramic substrate. In some preferred embodiments, the support substrate 102A is the ceramic substrate. The support substrate 102A includes ceramics as a major component. The support substrate 102A that is the ceramic substrate is superior in preventing permeation of water vapor and in heat resistance, which is preferable. The ceramic substrate may be obtained by, for example, firing a green sheet stacked body. Specifically, the ceramic substrate may be, for example, a low-temperature co-fired ceramic (LTCC) substrate, or may be a high-temperature co-fired ceramic (HTCC) substrate. Although the following ranges are mere examples, the support substrate 102A has a thickness of greater than or equal to 20 μm and less than or equal to 1000 μm, and may have a thickness of greater than or equal to 100 μm and less than or equal to 300 μm, for example.

### (Insulating Covering Film 102B)

The insulating covering film 102B is so provided as to cover at least a top surface 101A and a side surface 101C of the solid-state battery 101. As illustrated in FIG. 2, the entire solid-state battery 101 provided on the support substrate 102A is surrounded by the insulating covering film 102B. In some preferred embodiments, the insulating covering film 102B is so provided as to cover all of the top surface 101A and the side surface 101C of the solid-state battery 101. Of the two major surfaces included in the solid-state battery 101, a surface positioned relatively on an upper side is the top surface 101A. Of the two major surfaces included in the solid-state battery 101, a surface positioned relatively on a lower side is the bottom surface 101B. Accordingly, the top surface 101A is the major surface positioned on an opposite side to the support substrate 102A. It is therefore preferable that the insulating covering film 102B cover all of the surfaces of the solid-state battery 101, except for the bottom surface 101B. The insulating covering film 102B includes, for example, a resin material that is able to block water vapor. The insulating covering film 102B forms a favorable water vapor barrier together with the inorganic covering film 102C. Examples of a material included in the insulating covering film 102B include an epoxy-based resin, a silicone-based resin, and a liquid crystal polymer. Although the following ranges are mere examples, the insulating covering film 102B has a thickness of greater than or equal to 30 μm and less than or equal to 1000 μm, and may have a thickness of greater than or equal to 50 μm and less than or equal to 300 μm, for example.

### (Inorganic Covering Film 102C)

The inorganic covering film 102C is so provided as to cover the insulating covering film 102B. The inorganic covering film 102C is positioned on the insulating covering film 102B, and therefore has a form that surrounds, together with the insulating covering film 102B, the entire solid-state battery 101 on the support substrate 102A. A material included in the inorganic covering film 102C is not particularly limited as long as the material is an inorganic material. The inorganic covering film 102C may include, for example, a metal, glass, oxide ceramics, or a mixture thereof. In some preferred embodiments, the inorganic covering film 102C includes a metal component. That is, the inorganic covering film 102C may be a thin metal film. Although the following ranges are mere examples, the inorganic covering film 102C has a thickness of greater than or equal to 0.1 μm and less than or equal to 100 μm, and may have a thickness of greater than or equal to 1 μm and less than or equal to 50 μm, for example. The inorganic covering film 102C may be a dry plating film. As used herein, the dry plating film refers to a film that is obtainable by a vapor deposition method such as a physical vapor deposition (PVD) method or a chemical vapor deposition (CVD) method, and is a thin film having a markedly small thickness in nanometer or micrometer order. The dry plating film that is a thin film contributes to a decrease in size and thickness of the battery package 100. The dry plating film preferably includes, for example, at least one selected from the group consisting of aluminum (Al), nickel (Ni), palladium (Pd), silver (Ag), tin (Sn), gold (Au), copper (Cu), titanium (Ti), platinum (Pt), silicon (Si), and stainless steel. The dry plating film including such a component is chemically and thermally stable, and is therefore superior in a property such as chemical resistance, weather resistance, or heat resistance. This helps to provide the solid-state battery 101 with further improved long-term reliability.

In the battery package 100 illustrated in FIG. 2, the support substrate 102A is configured as a terminal substrate on which a substrate wiring 8 is provided. The substrate wiring 8 includes an external terminal adapted to couple the solid-state battery 101 and an external device to each other. The substrate wiring 8 of the support substrate 102A serving as the terminal substrate is not particularly limited, and may be any wiring that allows for electrical coupling between an upper surface and a lower surface of the support substrate 102A. In FIG. 2, the support substrate 102A is provided with the substrate wiring 8 including a via 8A and a pair of lands 8B and 8C. The land 8B is exposed at the upper surface of the support substrate 102A, and is electrically coupled to the positive electrode terminal 6 or the negative electrode terminal 7. The land 8C is exposed at the lower surface of the support substrate 102A. The via 8A is so provided through the support substrate 102A as to couple the land 8B and the land 8C to each other.

### <2.4 Manufacturing Method>

A brief description is given next of a method of manufacturing the battery package 100 of the disclosure. The battery package 100 is fabricable by, for example, a process of manufacturing the solid-state battery 101 and a process of packaging the solid-state battery 101.

### (Process of Manufacturing Solid-State Battery 101)

In manufacturing the stacked body 5 of the solid-state battery 101, used may be a printing method such as a screen printing method, a green sheet method in which a green sheet is used, or a combined method thereof.

One manufacturing method is described below as an example; however, the disclosure is not limited to the following manufacturing method. Temporal matters such as the order of descriptions below are merely for description convenience, and the disclosure is not limited thereto.

First, the positive electrode layer 10 is fabricated. Specifically, the positive electrode current collector 11 is prepared, following which positive electrode active material particles, a resin, and a solvent are mixed with each other to form a positive electrode slurry. Thereafter, the positive electrode slurry is applied onto both sides of the positive electrode current collector 11, following which the applied positive electrode slurry is dried to thereby form a green sheet for a positive electrode. Thereafter, the fabricated green sheet for a positive electrode is impregnated with a molten solid-state electrolyte for a positive electrode by, for example, dropping the molten solid-state electrolyte for a positive electrode onto the green sheet. As the molten solid-state electrolyte for a positive electrode, it is preferable to use at least one of Li₂CO₃, Li₂SO₄, Li₃BO₃, Li₃OCl, Li₂OHCl, Li₂(OH)Cl_{0.9}F_{0.1}, Li₂(OH)Cl_{0.9}Br_{0.1}, or Li₂(OH)Cl_{0.9}I_{0.1}. In such a manner, the positive electrode layer 10 is obtained.

Thereafter, the negative electrode layer 20 is fabricated. Specifically, negative electrode active material particles, a resin, and a solvent are mixed with each other to form a negative electrode slurry. Thereafter, the negative electrode slurry is applied onto a film, following which the applied negative electrode slurry is dried to form a green sheet for a negative electrode. Thereafter, the fabricated green sheet for a negative electrode is impregnated with a molten solid-state electrolyte for a negative electrode by, for example, dropping the molten solid-state electrolyte for a negative electrode onto the green sheet. As the molten solid-state electrolyte for a negative electrode, it is preferable to use at least one of Li₂CO₃, Li₂SO₄, Li₃BO₃, Li₃OCl, Li₂OHCl, Li₂(OH)Cl_{0.9}F_{0.1}, Li₂(OH)Cl_{0.9}Br_{0.1}, or Li₂(OH)Cl_{0.9}I_{0.1}. In such a manner, the negative electrode layer 20 is obtained.

Thereafter, the solid-state electrolyte layer 30 is fabricated in accordance with the procedure described in the first embodiment above.

Further, materials including, without limitation, an insulating material, a binder, an organic binder, a solvent, and any additive are mixed with each other to fabricate an insulating paste.

Thereafter, the positive electrode layer 10, the solid-state electrolyte layer 30, the negative electrode layer 20, and the solid-state electrolyte layer 30 are stacked on each other in order to fabricate a stacked structure. The stacked structure corresponds to one unit U illustrated in FIG. 3. In fabricating the stacked structure, the insulating paste is applied onto a location where the margin layers 41 and 42 are to be formed. The stacked structure is impregnated with a molten solid-state electrolyte for a solid-state electrolyte layer by, for example, dropping the molten solid-state electrolyte for a solid-state electrolyte layer onto the stacked structure, following which the resultant is dried. In such a manner, the stacked structure is impregnated with the solid-state electrolyte. As a result, the solid-state electrolyte layer 30 is obtained. As the molten solid-state electrolyte for a solid-state electrolyte layer, it is preferable to use a molten lithium salt including at least one of Li₂CO₃, Li₂SO₄, Li₃BO₃, Li₃OCl, or Li₂OHCl. The dried stacked structure is compressed by a method such as a cold isostatic press (CIP) method to compression-bond the positive electrode layer 10, the solid-state electrolyte layer 30, the negative electrode layer 20, and the solid-state electrolyte layer 30 to each other. Lastly, the stacked structure is fired in a nitrogen atmosphere at a temperature lower than 800° C. to thereby obtain the stacked body 5.

Thereafter, an electrically conductive paste is applied onto a side surface, of the sintered stacked body 5, where a portion of the positive electrode layer 10 is exposed. It is thereby possible to form the positive electrode terminal 6. In a similar manner, the electrically conductive paste is applied onto a side surface, of the sintered stacked body 5, where a portion of the negative electrode layer 20 is exposed. It is thereby possible to form the negative electrode terminal 7. Note that the positive electrode terminal 6 and the negative electrode terminal 7 do not necessarily have to be formed on the sintered stacked body 5. The positive electrode terminal 6 and the negative electrode terminal 7 may be formed on the stacked structure before firing and may be sintered together with the stacked structure.

It is thereby possible to obtain the solid-state battery 101.

### (Process of Packaging Solid-State Battery 101)

First, the support substrate 102A is prepared. The support substrate 102A may be obtained by, for example, stacking green sheets on each other and firing the stacked green sheets. The support substrate 102A may be prepared in a similar manner to, for example, formation of an LTCC substrate. The substrate wiring 8 including the via 8A and the lands 8B and 8C is formed in advance on the support substrate 102A. Specifically, the via 8A and the lands 8B and 8C are formed by, for example, forming a hole in a green sheet by means of, for example, a punch press or a carbon dioxide laser, and thereafter filling the formed hole with an electrically conductive paste material or performing a printing process, for example. Thereafter, a predetermined number of such green sheets are stacked on each other and thermocompression-bonded to each other to form a green sheet stacked body. The green sheet stacked body is fired. It is thereby possible to obtain the support substrate 102A on which the substrate wiring 8 is formed. Note that the substrate wiring 8 may be formed after firing the green sheet stacked body.

After the support substrate 102A is prepared as described above, the solid-state battery 101 is disposed on the support substrate 102A. At this time, the solid-state battery 101 is so disposed on the support substrate 102A that the substrate wiring 8 of the support substrate 102A and each of the positive electrode terminal 6 and the negative electrode terminal 7 of the solid-state battery 101 are electrically coupled to each other. Note that an electrically conductive paste including a material such as silver may be applied onto the substrate wiring 8 of the support substrate 102A, and the applied electrically conductive paste and each of the positive electrode terminal 6 and the negative electrode terminal 7 may be electrically coupled to each other.

Thereafter, the insulating covering film 102B is so formed as to cover the entire solid-state battery 101 on the support substrate 102A. When the insulating covering film 102B includes a resin material, the resin material is so applied as to cover the side surface 101C and the top surface 101A of the solid-state battery 101, following which the applied resin material is cured to thereby form the insulating covering film 102B. For example, the insulating covering film 102B may be shaped by applying pressure to the resin material with use of a mold having a predetermined shape. Note that the shaping of the insulating covering film 102B does not necessarily have to be performed by molding with use of the mold, and may be performed by another method such as polishing processing, laser processing, or a chemical process.

Thereafter, the inorganic covering film 102C is so formed as to cover the entire insulating covering film 102B. Specifically, the inorganic covering film 102C may be formed by performing, for example, dry plating.

Through the above-described processes, it is possible to obtain the battery package 100 in which the entire solid-state battery 101 placed on the support substrate 102A is covered with the insulating covering film 102B and the inorganic covering film 102C.

### <2.5 Action and Effects>

According to the battery package 100 including the solid-state battery 101 of the embodiment, the stacked body 5 of the solid-state battery 101 includes the solid-state electrolyte layer 30 including the solid-state electrolyte for a solid-state battery described in the first embodiment above. This allows the solid-state electrolyte layer 30 to have a high ion conductivity. Accordingly, it is possible for the solid-state battery 101 including the solid-state electrolyte layer 30 and the battery package 100 including the solid-state electrolyte layer 30 to achieve further superior performance. For example, it is possible for the solid-state battery 101 and the battery package 100 to allow for fast charging or to obtain high output.

### 3. Applications of Battery Package

A description is given next of applications (application examples) of the battery package including the solid-state battery described above.

The applications of the battery package are not particularly limited as long as they are, for example, machines, equipment, instruments, apparatuses, or systems (an assembly of a plurality of pieces of equipment, for example) in which the solid-state battery is usable mainly as a driving power source, an electric power storage source for electric power accumulation, or any other source. The battery package used as a power source may serve as a main power source or an auxiliary power source. The main power source is preferentially used regardless of the presence of any other power source. The auxiliary power source may be used in place of the main power source, or may be switched from the main power source on an as-needed basis. When the battery package is used as the auxiliary power source, the kind of the main power source is not limited to a power source including the solid-state battery.

Specific examples of the applications of the battery package include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use in which electric power is accumulated for a situation such as emergency. Note that the battery package may be applied to a battery module including a plurality of battery packages.

The battery module is effectively applied to relatively large-sized equipment, etc., including an electric vehicle, an electric power storage system, and an electric power tool. The electric vehicle is a vehicle that operates (travels) with the battery module as a driving power source, and may be an automobile that is additionally provided with a driving source other than the battery package including the solid-state battery. A hybrid automobile is an example of such an automobile. The electric power storage system is a system in which the battery package is used as an electric power storage source. The electric power storage system for home use accumulates electric power in the battery package serving as an electric power storage source, and the accumulated electric power may thus be utilized for using, for example, home appliances.

### 4. Examples

A description is given of Examples of the disclosure.

### Example 1

The solid-state battery 101 illustrated in FIG. 3 was fabricated, following which the solid-state battery 101 was evaluated for its battery characteristic as described below.

### (Fabrication of Positive Electrode Layer 10)

First, an aluminum foil having a thickness of 15 μm was prepared as the positive electrode current collector 11. Thereafter, the following materials were mixed with each other to obtain a positive electrode mixture: lithium nickel cobalt aluminum oxide (LiNiCoAlO₂) as the positive electrode active material; PVDF (polyvinylidene difluoride) as a positive electrode binder; and a conductive additive in which carbon black, acetylene black, and Ketjen black were mixed with each other. A mixture ratio between the positive electrode active material, the positive electrode binder, and the conductive additive was set to 95:3:2. Thereafter, the positive electrode mixture was put into NMP (N-methyl-2-pyrrolidone) as an organic solvent, following which the organic solvent into which the positive electrode mixture had been put was stirred to thereby prepare a positive electrode slurry in paste form. The stirring was performed by means of a hybrid mixer at a rotation speed of 2000 rpm for 3 minutes. Thereafter, the positive electrode slurry was applied onto a predetermined region of each of the opposite sides of the positive electrode current collector 11 by means of a coating apparatus, following which the applied positive electrode slurry was dried to thereby form a green sheet for a positive electrode on each of the opposite sides of the positive electrode current collector 11. Thereafter, the fabricated green sheets for a positive electrode were impregnated with molten Li₂(OH)Cl_{0.9}F_{0.1} as the molten lithium salt by dropping molten Li₂(OH)Cl_{0.9}F_{0.1} onto the green sheets. The positive electrode layer 10 was thus obtained.

### (Fabrication of Negative Electrode Layer 20)

The following materials were mixed with each other to obtain a negative electrode mixture: lithium titanium oxide (Li₄Ti₅O₁₂) as the negative electrode active material; polyimide as a negative electrode binder; and a conductive additive in which carbon black, acetylene black, and Ketjen black were mixed with each other. A mixture ratio between the negative electrode active material, the negative electrode binder, and the conductive additive was set to 90:5:5. Thereafter, the negative electrode mixture was put into NMP (N-methyl-2-pyrrolidone) as an organic solvent, following which the organic solvent into which the negative electrode mixture had been put was stirred to thereby prepare a negative electrode slurry in paste form. The stirring was performed by means of a hybrid mixer at a rotation speed of 2000 rpm for 3 μminutes. Thereafter, the negative electrode slurry was applied onto a release film including polyethylene terephthalate (PET) by means of a coating apparatus, following which the applied negative electrode slurry was dried to thereby form a green sheet for a negative electrode on the release film. Thereafter, the fabricated green sheet for a negative electrode was impregnated with molten Li₂(OH)Cl_{0.9}F_{0.1} as the molten lithium salt by dropping molten Li₂(OH)Cl_{0.9}F_{0.1} onto the green sheet. The negative electrode layer 20 was thus obtained.

### (Fabrication of Solid-State Electrolyte Layer 30)

Li₂(OH)Cl having an antiperovskite structure having a lattice constant of 3.91 Å as the solid-state electrolyte powder, Al₂O₃ as the non-lithium compound powder, and an organic binder were kneaded with each other to fabricate a kneaded powder body. Thereafter, the kneaded powder body was compression-molded while being heated by a hot isostatic press (HIP) method to fabricate a compression-molded body. At this time, the kneaded powder body was compression-molded while being heated at 270° C. lower than 292° C. at which Li₂(OH)Cl was to be melted. In such a manner, the solid-state electrolyte layer 30 was obtained.

### (Fabrication of Stacked Body 5)

Thereafter, the positive electrode layer 10, the solid-state electrolyte layer 30, the negative electrode layer 20, and the solid-state electrolyte layer 30, each of which had been fabricated as described above, were stacked on each other in order to fabricate a stacked structure. The stacked structure was fired in a nitrogen atmosphere at a temperature of 270° C. for 1 hour while being fixed with a pressure of 0.5 MPa by means of a jig to thereby obtain the stacked body 5.

Thereafter, the electrically conductive paste was applied onto a side surface, of the stacked body 5, where a portion of the positive electrode layer 10 was exposed, to thereby form the positive electrode terminal 6. The electrically conductive paste was applied onto a side surface, of the stacked body 5, where a portion of the negative electrode layer 20 was exposed, to thereby form the negative electrode terminal 7.

In such a manner, the solid-state battery 101 was obtained.

### (Battery Characteristic Evaluation)

Evaluation of the solid-state battery 101 for its battery characteristic revealed the result presented in Table 1. Here, the solid-state battery 101 was evaluated for an ion conductivity [S/cm] at 90° C. of the solid-state electrolyte layer 30. Specifically, the ion conductivity [S/cm] was measured within a frequency range from 100 μmHz to 1 MHz both inclusive with an AC amplitude voltage of 100 μmV by means of an AC impedance analyzer (1260A available from Solartron Analytical).

TABLE 1

| | | | Solid-state electrolyte layer | | |
|---|---|---|---|---|---|
| | | | | Non-Li compound | |
| | Active material | | | (Li compound in | Ion |
| | Positive | Negative | Solid-state | Comparative | conductivity |
| | electrode | electrode | electrolyte | examples4 and 5) | [S/cm] |
| Example 1 | LiNiCoAlO₂ | Li₄Ti₅O₁₂ | Li₂(OH)Cl | Al₂O₃ | 3.2 × 10⁻⁵ |
| Example 2 | LiNiCoAlO₂ | Li₄Ti₅O₁₂ | Li₂(OH)Cl | ZrO₂ | 3.1 × 10⁻⁵ |
| Example 3 | LiNiCoAlO₂ | Li₄Ti₅O₁₂ | Li₂(OH)Cl | TiO₂ | 3.0 × 10⁻⁵ |
| Example 4 | LiNiCoAlO₂ | Li₄Ti₅O₁₂ | Li₂(OH)Cl_{0.9}F_{0.1} | Al₂O₃ | 4.3 × 10⁻⁵ |
| Example 5 | LiNiCoAlO₂ | Li₄Ti₅O₁₂ | Li₃OCl | Al₂O₃ | 3.1 × 10⁻⁵ |
| Example 6 | LiNiCoAlO₂ | Li₄Ti₅O₁₂ | Li₂(OH)Cl_{0.9}F_{0.1} | MgO | 9.2 × 10⁻⁶ |
| Example 7 | LiNiCoAlO₂ | Li₄Ti₅O₁₂ | Li₂(OH)Cl_{0.9}F_{0.1} | AlN | 9.0 × 10⁻⁶ |
| Comparative example 1 | LiNiCoAlO₂ | Li₄Ti₅O₁₂ | Li₂(OH)Cl | — | 3.2 × 10⁻⁶ |
| Comparative example 2 | LiNiCoAlO₂ | Li₄Ti₅O₁₂ | Li₂(OH)Cl_{0.9}F_{0.1} | — | 8.3 × 10⁻⁶ |
| Comparative example 3 | LiNiCoAlO₂ | Li₄Ti₅O₁₂ | Li₃OCl | — | 5.3 × 10⁻⁶ |
| Comparative example 4 | LiNiCoAlO₂ | Li₄Ti₅O₁₂ | Li₂(OH)Cl | Li_{1.07}Al_{0.69}Ti_{1.46}(PO₄)₃ | 2.3 × 10⁻⁵ |
| Comparative example 5 | LiNiCoAlO₂ | Li₄Ti₅O₁₂ | Li₂(OH)Cl | Li₃FPO₄ | 1.7 × 10⁻⁵ |

### Example 2

The solid-state battery 101 was fabricated in a manner similar to that in Example 1, except that for fabrication of the solid-state electrolyte layer 30, ZrO₂ was used as the non-lithium compound powder as indicated in Table 1, following which the solid-state battery 101 was evaluated for its battery characteristic in a manner similar to that in Example 1. The result of the evaluation is also presented in Table 1.

### Example 3

The solid-state battery 101 was fabricated in a manner similar to that in Example 1, except that for fabrication of the solid-state electrolyte layer 30, TiO₂ was used as the non-lithium compound powder as indicated in Table 1, following which the solid-state battery 101 was evaluated for its battery characteristic in a manner similar to that in Example 1. The result of the evaluation is also presented in Table 1.

### Example 4

The solid-state battery 101 was fabricated in a manner similar to that in Example 1, except that for fabrication of the solid-state electrolyte layer 30, Li₂(OH)Cl_{0.9}F_{0.1} was used as the solid-state electrolyte powder as indicated in Table 1, following which the solid-state battery 101 was evaluated for its battery characteristic in a manner similar to that in Example 1. The result of the evaluation is also presented in Table 1.

### Example 5

The solid-state battery 101 was fabricated in a manner similar to that in Example 1, except that for fabrication of the solid-state electrolyte layer 30, Li₃OCl was used as the solid-state electrolyte powder as indicated in Table 1, following which the solid-state battery 101 was evaluated for its battery characteristic in a manner similar to that in Example 1. The result of the evaluation is also presented in Table 1.

### Example 6

The solid-state battery 101 was fabricated in a manner similar to that in Example 1, except that for fabrication of the solid-state electrolyte layer 30, Li₂(OH)Cl_{0.9}F_{0.1} was used as the solid-state electrolyte powder and MgO was used as the non-lithium compound powder as indicated in Table 1, following which the solid-state battery 101 was evaluated for its battery characteristic in a manner similar to that in Example 1. The result of the evaluation is also presented in Table 1.

### Example 7

The solid-state battery 101 was fabricated in a manner similar to that in Example 1, except that for fabrication of the solid-state electrolyte layer 30, Li₂(OH)Cl_{0.9}F_{0.1} was used as the solid-state electrolyte powder and AlN was used as the non-lithium compound powder as indicated in Table 1, following which the solid-state battery 101 was evaluated for its battery characteristic in a manner similar to that in Example 1. The result of the evaluation is also presented in Table 1.

### Comparative Example 1

The solid-state battery 101 was fabricated in a manner similar to that in Example 1, except that for fabrication of the solid-state electrolyte layer 30, the non-lithium compound powder was not kneaded with the solid-state electrolyte powder and the organic binder as indicated in Table 1, following which the solid-state battery 101 was evaluated for its battery characteristic in a manner similar to that in Example 1. The result of the evaluation is also presented in Table 1.

### Comparative Example 2

The solid-state battery 101 was fabricated in a manner similar to that in Example 1, except that for fabrication of the solid-state electrolyte layer 30, Li₂(OH)Cl_{0.9}F_{0.1} was used as the solid-state electrolyte powder and the non-lithium compound powder was not kneaded with the solid-state electrolyte powder and the organic binder as indicated in Table 1, following which the solid-state battery 101 was evaluated for its battery characteristic in a manner similar to that in Example 1. The result of the evaluation is also presented in Table 1.

### Comparative Example 3

The solid-state battery 101 was fabricated in a manner similar to that in Example 1, except that for fabrication of the solid-state electrolyte layer 30, Li₃OCl was used as the solid-state electrolyte powder and the non-lithium compound powder was not kneaded with the solid-state electrolyte powder and the organic binder as indicated in Table 1, following which the solid-state battery 101 was evaluated for its battery characteristic in a manner similar to that in Example 1. The result of the evaluation is also presented in Table 1.

### Comparative Example 4

The solid-state battery 101 was fabricated in a manner similar to that in Example 1, except that for fabrication of the solid-state electrolyte layer 30, Li_{1.07}Al_{0.69}Ti_{1.46}(PO₄)₃ that was a lithium compound was kneaded, instead of the non-lithium compound powder, with the solid-state electrolyte powder and the organic binder as indicated in Table 1, following which the solid-state battery 101 was evaluated for its battery characteristic in a manner similar to that in Example 1. The result of the evaluation is also presented in Table 1.

### Comparative Example 5

The solid-state battery 101 was fabricated in a manner similar to that in Example 1, except that for fabrication of the solid-state electrolyte layer 30, Li₃PO₄ that was a lithium compound was kneaded, instead of the non-lithium compound powder, with the solid-state electrolyte powder and the organic binder as indicated in Table 1, following which the solid-state battery 101 was evaluated for its battery characteristic in a manner similar to that in Example 1. The result of the evaluation is also presented in Table 1.

### Discussion

As indicated in Table 1, in each of Examples 1 to 3 in which the solid-state electrolyte layer was used that included Li₂(OH)Cl as the solid-state electrolyte and the non-Li compound, the ion conductivity at 90° C. had a higher numerical value, as compared with that in Comparative example 1 in which the solid-state electrolyte layer was used that included only Li₂(OH)Cl as the solid-state electrolyte. Further, in each of Examples 1 to 3, the ion conductivity at 90° C. had a higher numerical value, as compared with those in Comparative examples 4 and 5 in which the solid-state electrolyte layer was used that included Li₂(OH)Cl as the solid-state electrolyte and the Li compound. In each of Examples 4, 6, and 7 in which the solid-state electrolyte layer was used that included Li₂(OH)Cl_{0.9}F_{0.1} as the solid-state electrolyte and the non-Li compound, the ion conductivity at 90° C. had a higher numerical value, as compared with that in Comparative example 2 in which the solid-state electrolyte layer was used that included only Li₂(OH)Cl_{0.9}F_{0.1} as the solid-state electrolyte. Further, in Example 5 in which the solid-state electrolyte layer was used that included Li₃OCl as the solid-state electrolyte and the non-Li compound, the ion conductivity at 90° C. had a higher numerical value, as compared with that in Comparative example 3 in which the solid-state electrolyte layer was used that included only Li₃OCl as the solid-state electrolyte.

It was confirmed from the above results that combining the lithium salt solid-state electrolyte part and the non-lithium compound part including no lithium allows the solid-state electrolyte for a solid-state battery of the disclosure to have a favorable ion conductive property.

Although the disclosure has been described above with reference to some embodiments, modifications, and Examples, the configuration of the disclosure is not limited to those described above, and is therefore modifiable in a variety of ways.

Specifically, in the second embodiment, for example, the description has been given of the battery package 100 in which the solid-state battery 101 is placed on the support substrate 102A and is packaged; however, the battery package of the disclosure is not limited to this embodiment. For example, in one embodiment, the support substrate may be omitted and sealing may be achieved simply by, for example, the insulating covering film and the inorganic covering film.

Further, in the first embodiment above, the description has been given of the case where the electrode reactant is lithium; however, the electrode reactant is not particularly limited. Therefore, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the disclosure are not limited to those described herein. Accordingly, the disclosure may achieve any other effect.

1. A solid-state electrolyte for a solid-state battery, the solid-state electrolyte comprising:
a lithium salt solid-state electrolyte part; and
a non-lithium compound part embedded in the lithium salt solid-state electrolyte part.

2. The solid-state electrolyte for a solid-state battery according to claim 1, wherein the lithium salt solid-state electrolyte part has a melting point of 400 degrees Celsius or lower.

3. The solid-state electrolyte for a solid-state battery according to claim 1, wherein the lithium salt solid-state electrolyte part includes at least one of Li₃OCl, Li₂(OH)Cl, or Li₂(OH)Cl_{0.9}F_{0.1}.

4. The solid-state electrolyte for a solid-state battery according to claim 1, wherein the lithium salt solid-state electrolyte part has an antiperovskite structure.

5. The solid-state electrolyte for a solid-state battery according to claim 1, wherein the non-lithium compound part includes an inorganic insulating material.

6. The solid-state electrolyte for a solid-state battery according to claim 5, wherein the inorganic insulating material comprises a metal oxide or a metal nitride.

7. The solid-state electrolyte for a solid-state battery according to claim 5, wherein the inorganic insulating material comprises Al₂O₃, ZrO₂, TiO₂, MgO, or AlN.

8. The solid-state electrolyte for a solid-state battery according to claim 1, wherein the non-lithium compound part has a median diameter D50 of greater than or equal to 5 nanometers and less than or equal to 5 μmicrometers.

9. A solid-state battery comprising:
a positive electrode;
a negative electrode; and
a solid-state electrolyte layer interposed between the positive electrode and the negative electrode, wherein the solid-state electrolyte layer includes:
a lithium salt solid-state electrolyte part, and
a non-lithium compound part embedded in the lithium salt solid-state electrolyte part.

10. The solid-state battery according to claim 9, wherein the lithium salt solid-state electrolyte part has a melting point of 400 degrees Celsius or lower.

11. The solid-state battery according to claim 9, wherein the lithium salt solid-state electrolyte part includes at least one of Li₃OCl, Li₂(OH)Cl, or Li₂(OH)Cl_{0.9}F_{0.1}.

12. The solid-state battery according to claim 9, wherein the lithium salt solid-state electrolyte part has an antiperovskite structure.

13. The solid-state battery according to claim 9, wherein the non-lithium compound part includes an inorganic insulating material.

14. The solid-state battery according to claim 13, wherein the inorganic insulating material comprises a metal oxide or a metal nitride.

15. The solid-state battery according to claim 13, wherein the inorganic insulating material comprises Al₂O₃, ZrO₂, TiO₂, MgO, or AlN.

16. The solid-state battery according to claim 9, wherein the non-lithium compound part has a median diameter D50 of greater than or equal to 5 nanometers and less than or equal to 5 μmicrometers.

17. A battery package comprising:
a solid-state battery; and
a covering part covering the solid-state battery, wherein
the solid-state battery includes:
a positive electrode,
a negative electrode, and
a solid-state electrolyte layer interposed between the positive electrode and the negative electrode, and the solid-state electrolyte layer includes:
a lithium salt solid-state electrolyte part, and
a non-lithium compound part embedded in the lithium salt solid-state electrolyte part.

18. The battery package according to claim 17, wherein the lithium salt solid-state electrolyte part has a melting point of 400 degrees Celsius or lower.

19. The battery package according to claim 17, wherein the lithium salt solid-state electrolyte part has an antiperovskite structure.

20. The battery package according to claim 17, wherein the non-lithium compound part includes an inorganic insulating material.
